(19) United States
(12) Patent Application Publication
(10) Pub. No.: US 2003/0126480 A1
(43) Pub. Date: Jul. 3, 2003

(54) Portable computer and power controlling method thereof

(75) Inventor: Jong-ho Song, Yongin city (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/187,301

(22) Filed: Jul. 2, 2002

(30) Foreign Application Priority Data
Dec. 29, 2001 (KR) 2001-87945

(51) Int. Cl. G06F 1/26

(52) U.S. Cl. 713/300

(57) ABSTRACT

A portable computer including a power switch, a power supply receiving electric power from one of a battery and an adapter; a system board mounted with a central processing unit and a plurality of hardware components, a microcomputer controlling the electric power from the power supply to be supplied to the system board when the power switch is on, and a battery power indicating part being operated by driving power of the microcomputer. The microcomputer detects remaining power of the battery according to whether the power switch is on when the electric power is supplied from the battery, and controls the battery power indicating part to indicate low power of the battery and the system board to not be turned on when the remaining power of the battery is lower than a predetermined voltage level. With this configuration, a portable computer and a power controlling method thereof, indicate low power of a battery when the portable computer is turned on in a state that the remaining power of the battery is not enough to operate the portable computer.

### CROSS-REFERENCE TO RELATED APPLICATIONS

This application claims the benefit of Korean Application No. 2001-87945, filed Dec. 29, 2001, in the Korean Patent Office, the disclosure of which is incorporated herein by reference.

### BACKGROUND OF THE INVENTION

1. Field of the Invention

The present invention relates in general to a portable computer, and more particularly, to a portable computer and a power controlling method thereof, which can operate an LED (light-emitting diode) to indicate a low power of a battery when the portable computer is turned on.

2. Description of the Related Art Field of the Invention

Generally, a portable computer comprises a main body equipped with a system board mounted with a CPU (central processing unit) and a microcomputer, a display part rotatably combined with the main body and displaying a picture thereon, and a power supply supplying electric power to the system board and the display part.

The portable computer operates using electric power supplied from an electric outlet through an adapter, or supplied from a battery where the electric outlet is absent.

FIG. 3 is a block diagram illustrating a power control of a conventional portable computer. As shown in FIG. 3, in the conventional portable computer, when a power switch 21 is on, a microcomputer 23 controls a power supply 25 to supply electric power to a system board 27 and a power LED (light-emitting diode) 24, and turns on the power LED 24 indicating that the system board 27 is operating. The power supply 25 converts the electric power supplied from a battery or an adapter into various driving voltages (e.g., 1.5V, 3.3V, 5V, etc.), and, in particular, the driving voltage of 3.3V is supplied to the power LED 24.

Referring to FIG. 4, the process of controlling power in the conventional portable computer will be described hereinbelow. First, if the portable computer is turned on (P1), whether the electric power is supplied from the adapter or the battery (P3) is detected. In the case where electric power is supplied by the adapter, the electric power from the adapter is supplied to the system board 27 (6). However, in the case where electric power is supplied by the battery, the remaining power of the battery is detected (P5). If the remaining power of the battery is enough to operate the portable computer, the electric power from the battery is supplied to the system board 27 (P6), but if the remaining power of the battery is not enough to operate the portable computer (P7), the system board is not turned on (P9) and the electric power from the battery is not supplied to the system board. The remaining power of the battery can be displayed by software when the system board 27 of the portable computer operates, so that a user can check the remaining power of the battery.

However, if the system board is not turned on, a user cannot possibly check the remaining power of the battery. Therefore, when the portable computer does not operate, a user cannot know whether the power of the battery is low or the system board is out of order.

### SUMMARY OF THE INVENTION

Accordingly, a portable computer and a power controlling method thereof is provided, in which a microcomputer drives a battery power indicating part to indicate low power of a battery when the portable computer is turned on and in the state where the remaining power of the battery is not sufficient to operate the portable computer.

Additional objects and advantages of the invention will be set forth in part in the description which follows and, in part, will be obvious from the description, or may be learned by practice of the invention.

The above and other objects of the present invention may be accomplished by a portable computer comprising a power switch; a power supply receiving electric power from one of a battery and an adapter; a system board mounted with a central processing unit and a plurality of hardware components; a microcomputer controlling the electric power from the power supply to be supplied to the system board when the power switch is on; and a battery power indicating part being operated by driving power of the microcomputer, and wherein the microcomputer detects remaining power of the battery according to the power switch being on when the electric power is supplied from the battery, and controls the battery power indicating part to indicate low power of the battery and preventing the system board from being turned on when the remaining power of the battery is lower than a predetermined voltage level.

According to an aspect of the present invention, the battery power indicating part is comprised of a power LED which is operated while the power switch is on. Also, the microcomputer controls the power LED to blink for a predetermined period of time when the remaining power of the battery is lower than a predetermined voltage level.

According to another aspect of the present invention, the above and other objects may be also achieved by a power controlling method of a portable computer comprising a power switch, a power supply receiving electric power from one of a battery and an adapter, a central processing unit, and a system board mounted with a plurality of hardware components, comprising detecting whether the electric power is supplied from the battery when the power switch is on; detecting remaining power of the battery where the battery supplies the electric power; and indicating low power of the battery with a power LED operated by a driving power of a microcomputer when the remaining power of the battery is lower than a predetermined voltage level, and preventing the system board from being turned on.

The indicating of the low power of the battery is comprised of controlling the power LED to blink for a predetermined period of time.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram for controlling a power LED of a portable computer according to an embodiment of the present invention;

FIG. 2 is a flow chart illustrating a power control of the portable computer shown in FIG. 1 according to an embodiment of the present invention;

FIG. 3 is a block diagram illustrating a power control of a conventional portable computer; and

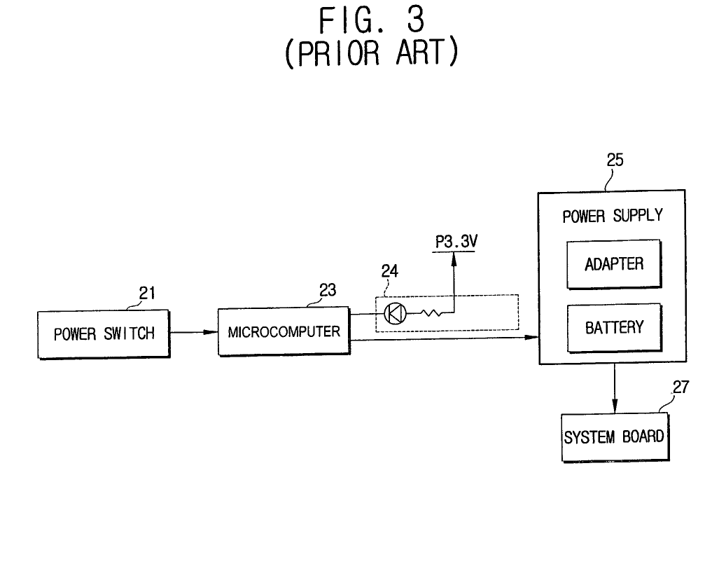

FIG. 4 is a flow chart illustrating a power control of the conventional portable computer shown in FIG. 1.

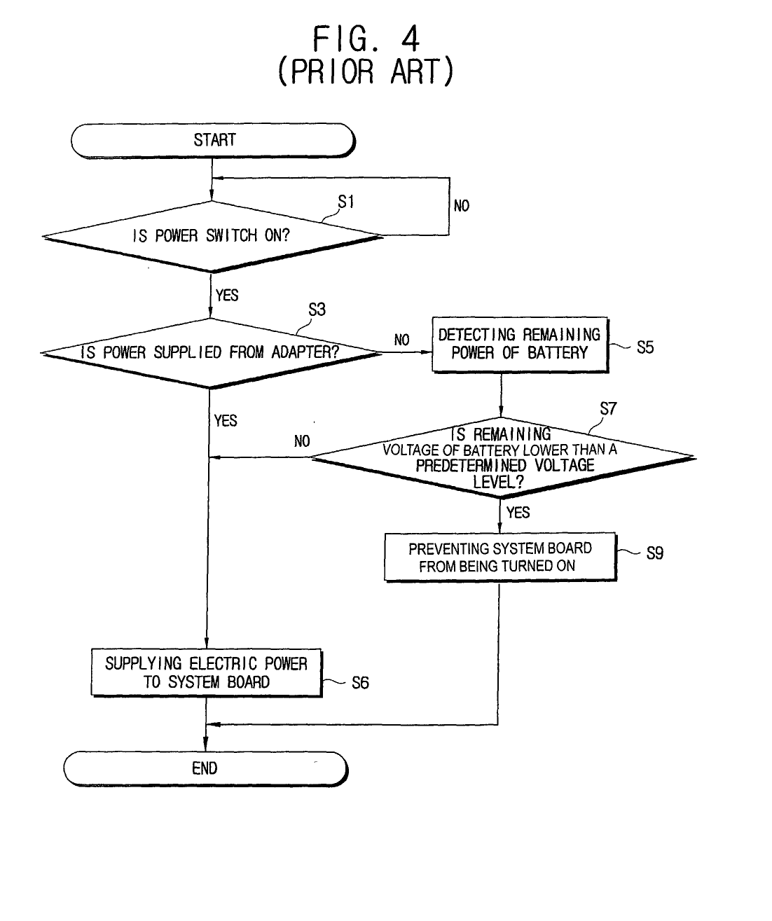

### DETAILED DESCRIPTION OF THE PREFERRED EMBODIMENT

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

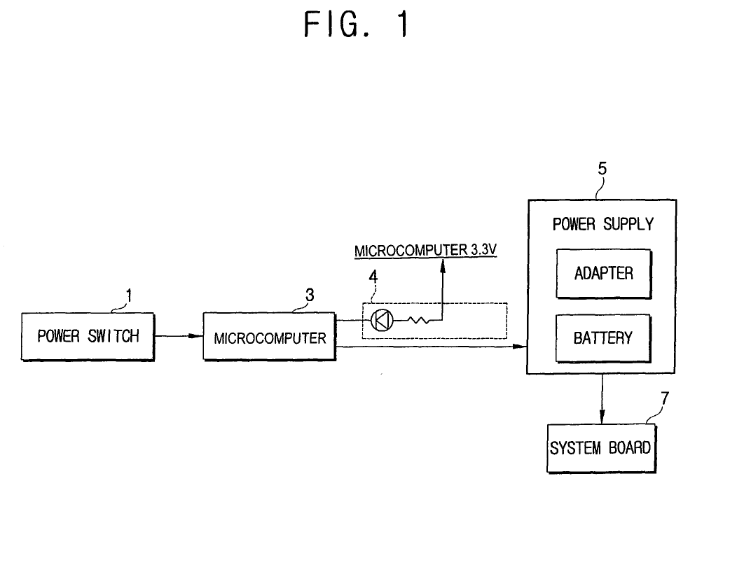

FIG. 1 is a block diagram for controlling a power LED of a portable computer according to an embodiment of the present invention. As shown in FIG. 1, a portable computer comprises a power switch 1, a power supply 5 receiving electric power from one of a battery and an adapter, a microcomputer 3 detecting whether the power switch 1 is on or off and controlling various driving voltages (e.g. 1.5V, 3.3V, 5V, etc.) converted by the power supply 5 to be supplied to a system board 7, and a battery power indicating part 4 indicating remaining power of the battery in the case that the electric power is supplied from the battery when the power switch 1 is on.

In the following embodiment of the present invention, a power LED (light-emitting diode) indicating whether the system board 7 is turned on or off will be used as the battery power indicating part 4. The power LED used as the battery power indicating part 4 receives the driving voltage (3.3V) of the microcomputer 3 and is turned on or off according to a control signal of the microcomputer 3.

Because the microcomputer 3 operates independently of whether the power switch 1 is on or off, if only the power supply 5 is connected to the battery or the adapter, the microcomputer 3 connected to the power supply 5 always detects whether the power switch is on, and controls the electric power from the power supply 5 to be supplied to the system board 7. Herein, the microcomputer 3 detects whether the electric power of the power supply 5 is supplied from the battery or the adapter. In the case that the electric power is supplied from the battery when the power switch 1 is on, the microcomputer 3 detects the remaining power of the battery. If the remaining power of the battery is lower than a predetermined voltage level, the microcomputer 3 controls the power LED used as the battery power indicating part 4 to blink for a predetermined period of time and the system board 7 to be not turned on. At this time, because the power LED is operated by the driving power of the microcomputer 3, the power LED can indicate the remaining power of the battery even if the power switch is off due to the low power of the battery.

However, where the electric power is supplied from the adapter or the remaining power of the battery is sufficient to operate the system board 7, the microcomputer 3 controls the electric power to be supplied to the system board 7 and the battery power indicating part 4, namely, the power LED to be turned on.

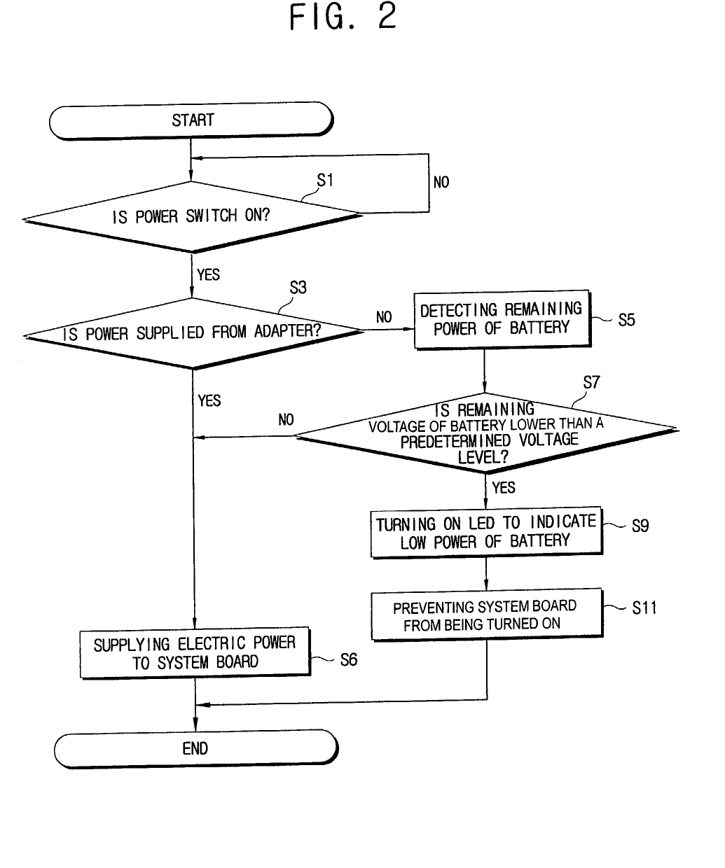

FIG. 2 is a flow chart illustrating a power control of the portable computer according to an embodiment of the present invention. As shown in FIG. 2, when the power switch 1 is on, the microcomputer 3 recognizes that the power switch 1 is on (S1), and determines whether the electric power is supplied from the adapter or the battery (S3). In the case where the electric power is supplied by the adapter, the electric power is supplied to the system board 7 (S6), thereby operating hardware components. In the case where the electric power is supplied by the battery, the microcomputer 3 detects the remaining power of the battery (S5), and determines whether or not the remaining power of the battery is lower than a predetermined voltage level (S7). If the remaining power of the battery is lower than the predetermined voltage level, the microcomputer 3 applies the control signal to the power LED so as to make the power LED blink, thereby indicating to a user that the power of the battery is low (S9) and keeping the system board 7 from being turned on (S11). However, if the remaining power of the battery is enough to operate the system board 7, the electric power is supplied to the system board 7(S6), thereby operating hardware components and turning on the power LED.

In the above description, the battery power indicating part 4 is operated by the driving voltage (3.3V) of the microcomputer 3. However, a dry cell having a predetermined voltage may be used as the driving voltage of the microcomputer 3.

In the above description, when the power of the battery is low, the battery power indicating part 4 begins to blink, but the battery power indicating part 4 may be continuously turned on according to the control signal of the microcomputer 3.

With this configuration, in a portable computer operated by electric power supplied from a battery without an adapter, the remaining power of the battery is detected when a power switch is on, and a power LED indicates that the power of the battery is low when the power of the battery is not enough to operate the portable computer, thereby allowing a user to check the power of the battery.

As described above, the present invention provides a portable computer and a power controlling method thereof, in which a microcomputer drives a battery power indicating part to indicate low power of a battery when the portable computer is turned on and in the state that the remaining power of the battery is not enough to operate the portable computer.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A portable computer comprising:
a power switch;
a power supply receiving electric power from one of a battery and an adapter;
a system board mounted with a central processing unit and a plurality of hardware components;
a microcomputer controlling the electric power from the power supply to be supplied to the system board when the power switch is on; and
a battery power indicating part being operated by driving power of the microcomputer;
wherein the microcomputer detects a remaining voltage of the battery according to whether the power switch is on when the electric power is supplied from the battery, and controls the battery power indicating part to indicate low power of the battery and the system board to not be turned on when the remaining voltage of the battery is lower than a predetermined voltage level.

2. The portable computer according to claim 1, wherein the battery power indicating part comprises a power LED which is operated while the power switch is on.

3. The portable computer according to claim 2, wherein the microcomputer controls the power LED to blink for a predetermined period of time when the remaining voltage of the battery is lower than a predetermined voltage level.

4. A power controlling method of a portable computer comprising a power switch, a power supply receiving electric power from one of a battery and an adapter, a central processing unit, and a system board mounted with a plurality of hardware components, comprising:
detecting whether the electric power is supplied from the battery when the power switch is on;
detecting remaining voltage of the battery where the battery supplies the electric power; and
indicating low power of the battery with a power LED operated by driving power of a microcomputer when the remaining voltage of the battery is lower than a predetermined voltage level, and preventing the system board from being turned on.

5. The method according to claim 4, wherein the indicating of the low power of the battery comprises controlling the power LED to blink for a predetermined period of time.

6. The method according to claim 5, further comprising:
setting the predetermined voltage at a level for which a remaining power of the battery is insufficient to power the microcomputer.

7. A portable computer comprising:
a power switch;
a power supply receiving electric power from one of a battery and an adapter;
a microcomputer controlling the electric power from the power supply to be supplied to a system board mounted with a central processing unit and a plurality of hardware components when the power switch is on; and
a battery power indicating part being operated by a driving power of the microcomputer;
wherein the microcomputer detects a remaining voltage of the battery if the power switch is on and the electric power is supplied from the battery, and controls the battery power indicating part to indicate low power of the battery when the remaining voltage of the battery is lower than a predetermined voltage.

8. The portable computer according to claim 7, wherein the battery power indicating part comprises a power LED which is operated while the power switch is on.

9. The portable computer according to claim 7, wherein the microcomputer controls the power LED to blink for a predetermined period of time when the remaining voltage of the battery is lower than a predetermined voltage.

10. The portable computer according to claim 7, wherein the microcomputer controls the power LED to blink for different times according to a low power condition of the battery.

11. The portable computer according to claim 7, wherein the microcomputer controls a control signal to the battery power indicating part according to a low power condition.

12. A power controlling method of a portable computer comprising a power switch, a power supply receiving electric power from one of a battery or an adapter, a central processing unit, and a system board mounted with a plurality of hardware components, comprising:
detecting whether the electric voltage is supplied from the battery when the power switch is on;
detecting a remaining voltage of the battery where the battery supplies the electric power; and
indicating low power of the battery with a power LED operated by driving power of a microcomputer when the remaining voltage of the battery is lower than a predetermined voltage level,
maintaining a power off condition of the system board when indicating a low power condition.

13. The method according to claim 12, further comprising:
controlling the power LED to be continuously turned on according to the low power condition.

14. The method according to claim 12, further comprising:
controlling the power LED to blink for a predetermined period of time according to the low power condition.
